(19) United States
(12) Patent Application Publication
(10) Pub. No.: US 2009/0138107 A1
(43) Pub. Date: May 28, 2009

(54) LAUNDRY APPARATUS

(76) Inventor: Mi Kyung HA, Changwon-si (KR)

Correspondence Address: KED & ASSOCIATES, LLP, P.O. Box 221200, Chantilly, VA, 20153-1200, US

(21) Appl. No.: 12/255,011

(22) Filed: Oct. 21, 2008

(30) Foreign Application Priority Data
Oct. 23, 2007 (KR) 10-2007-0106470

(51) Int. Cl. G06F 17/00

(52) U.S. Cl. 700/90

(57) ABSTRACT

A laundry apparatus including a radio-communication device and a radio-communication control part, only to make possible communication with a mobile phone having a radio-communication device is disclosed. Therefore, according to the embodiment of the present invention, without an auxiliary remote control, the user may identify the information of the laundry apparatus remote or may control the laundry apparatus. Furthermore, the laundry apparatus according to the embodiment may receive a new operation control program from the mobile phone having the radio-communication device and the new operation control program may be installed in the laundry apparatus. As a result, changing demands of consumers may be satisfied.

### CROSS REFERENCE TO RELATED APPLICATION

This application claims the benefit of the Patent Korean Application No. 10-2007-0106470 filed on Oct. 23, 2007, which is hereby incorporated by reference as if fully set forth herein.

### BACKGROUND OF THE DISCLOSURE

1. Field of the Disclosure

The present invention relates to a laundry apparatus. More particularly, the present invention relates to a laundry apparatus including a radio-communication device and a radio-communication control part, only to make possible communication with a mobile phone having a radio-communication device.

2. Discussion of the Related Art

Typically, laundry apparatuses are electric appliances which use a power of a mechanism. A laundry apparatus includes an electric motor as main power supply source. Using water and detergent, the laundry apparatus removes dirt from washing objects (hereinafter, laundry) through a washing, rinsing and spinning cycle. The conventional laundry apparatus includes a motor as a power supply source, a mechanism part transmitting energy, an operation control part controlling an overall washing, a water supply device and water drain device, and a steam supply device or hot air supply device.

A program controlling components of the laundry apparatus, a cycle mode and an operation method of the laundry apparatus may be stored in the operation control part.

It is impossible in the conventional laundry apparatus to change the preset cycle mode and operation method. Accordingly, the conventional laundry apparatus fails to satisfy changing demands of users. As a result, once a laundry apparatus is purchased, the laundry apparatus is usable in the same cycle mode and operation method inputted in the production line of the laundry apparatus until the end of the usage life of the laundry apparatus.

A laundry apparatus may be occasionally installed inside a house where a user lives but the laundry apparatus is commonly installed outside the house or in a laundry room. In case of a laundry apparatus having a remote control, a user can control the laundry apparatus remote. However, there are little kinds of laundry apparatuses having remote controls and the cost of adding a remote control to a laundry apparatus will end up the high price of the laundry apparatus. In addition, there are many different infrared communications of such the remote controls and they are not compatible with each other.

Moreover, if a user operates a conventional remote control, the remote control emits infrared rays to controls a laundry apparatus. The infrared rays are pulse-code modulated (PCM) to be on and off intermittently by a binary encoding. Hence, an infrared receiver provided in an electric appliance combines the codes and transmits the result of the code combination to an operation circuit provided in a control part, such that the electric appliance may be controlled.

However, the information cannot be transmitted in a reverse direction and the user at a different place cannot identify whether an electric appliance such as a laundry apparatus operates normally or how far a washing process is performed.

Therefore, the laundry apparatus according to the present invention is provided to be controlled by a mobile phone wirelessly, the laundry apparatus including a radio-communication device capable of storing information on a new operation method which is received from the mobile phone.

### SUMMARY OF THE DISCLOSURE

Accordingly, the present invention is directed to a laundry apparatus.

Additional advantages, objects, and features of the disclosure will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a laundry apparatus includes a laundry device washing or drying laundry; an operation control part controlling components of the laundry device; a radio-communication device able to radio-communicate with a mobile phone, the mobile phone having a radio-communication device which communicates the radio-communication device; and a radio-communication control part exchanging data with the operation control part, the radio-communication control part controlling the radio-communication device.

The radio-communication control part may include a radio-communication processing unit processing data generated during the radio-communication; and a radio-communication memory part in which a radio-communication control program is stored, with an auxiliary storage space, the radio control program run in the radio-communication processing unit to control the radio-communication device.

A radio control program is stored in the auxiliary storage space of the radio-communication memory part, the radio control program which is transmittable to and installable in the mobile phone to control the laundry apparatus.

The radio control program may be wirelessly transmitted to the mobile phone via the radio-communication device of the laundry apparatus.

The radio-communication control part may collect information on an operation state of the laundry apparatus from the operation control part to transmit the collected information to the mobile phone via the radio-communication device of the laundry apparatus.

The information on the operation state which is transmitted to the mobile phone may be selected by a user.

The information on the operation state transmitted to the mobile phone may be displayed via the mobile phone, with the radio control program being run.

The radio-communication control part may collect or transmit the information on the operation state of the laundry apparatus, if a request signal of the information on the operation state is received.

The information on the operation state of the laundry apparatus may include information on operation completion of the laundry apparatus.

The radio control program may transmit a control signal of the laundry apparatus to the laundry apparatus via the radio-communication device of the mobile phone, if a control signal of the laundry apparatus is inputted by a user.

The control signal may be transmitted to the operation control part, after passing the radio-communication device and the radio-communication device of the laundry apparatus, to control the components of the laundry device.

A new operation control program of the laundry apparatus stored in the mobile phone may be added to an existing one stored in the operation control part or the existing one is replaced with the new operation control program, if a new operation control program of the laundry apparatus stored in the mobile phone is transmitted.

The operation control program may include a new operation mode of the laundry apparatus.

The radio-communication device of the mobile phone and the radio-communication device of the laundry apparatus may be Bluetooth modules.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a diagram schematically illustrating a configuration of a laundry apparatus according to an exemplary embodiment;

FIG. 2 is a flow chart of a control signal if the laundry apparatus is controlled by a mobile phone;

FIG. 3A is a flow chart of a control signal if information on an operational state of the laundry apparatus is transmitted to the mobile phone;

FIG. 3B is a flow chart of a control signal if the laundry apparatus according to the exemplary embodiment provides information with the mobile phone automatically; and

FIG. 4 is a diagram illustrating a transmission path of an operation control program if an operation control program of the laundry apparatus is added or changed.

### DESCRIPTION OF SPECIFIC EMBODIMENTS

Reference will now be made in detail to the specific embodiments of the present invention, examples of which are illustrated in the accompanying drawings. Wherever possible, the same reference numbers will be used throughout the drawings to refer to the same or like parts.

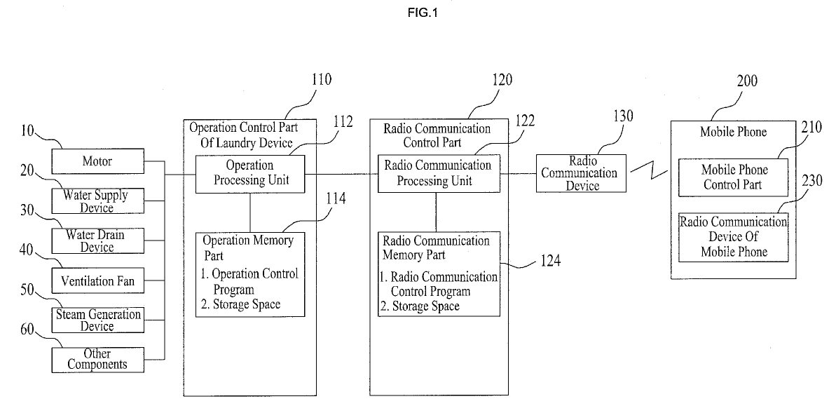

FIG. 1 is a conceptual diagram of a laundry apparatus according to an exemplary embodiment. The laundry apparatus includes a laundry device, an operation control part, a radio-communication device and a radio-communication control part. The laundry device washes or dries laundry. The operation control part controls overall components of the laundry device. The radio-communication device is in radio-communication with a mobile phone having a radio-communication device which is an identical kind to the radio-communication device. The radio-communication control part exchanges data with the operation control part, with controlling the radio-communication device.

That is, a control part of the laundry apparatus includes an operation control part 110 controlling an overall operation of the laundry device and a radio-communication control part 120 controlling a radio-communication device 130 provided in the laundry apparatus.

The radio-communication control part 120 includes a radio-communication processing unit 122 and a memory part 124. The radio-communication processing unit 122 processes data which is generated during the radio-communication. The memory part 124 includes a radio-communication control program run in the radio-communication processing unit 122 to control the radio-communication device 130 and an auxiliary storage space.

The operation control part 110 may be configured of a micro controller unit (MCO) and various kinds of operation programs are inputted and stored in the operation memory part 114 composing the operation control part 110, such that the operation control part 110 may control the laundry device of the laundry apparatus. Here, the laundry device includes various kinds of mechanism components to wash or dry laundry.

The components of the laundry device may be a motor 10, a water supply device 20, a water drain device 30, a ventilation fan 40 and a steam generation device 50.

As mentioned above, the operation control part 110 controlling the operation of the laundry apparatus includes the operation memory part 114 and the operation control program is stored in the operation memory part 114 to control the components of the laundry apparatus. Here, information on an operation method or various cycle modes of the laundry apparatus may be programmed and stored in the operation memory part 114.

According to the conventional laundry apparatus, the operation control program stored in the operation memory part 114, for example, an operation method or a cycle mode cannot be changeable. Even if a new operation method or cycle mode of the laundry apparatus is developed by its manufacturer, it is quite difficult to apply or add the new method or cycle.

To solve that, the laundry apparatus according to the exemplary embodiment includes the radio-communication control part 120 which is communication with the operation control part 110. The radio-communication control part 120 includes a radio-communication processing unit 122 and a radio-communication memory part 124, like the operation control part 110.

The radio-communication control part 120 controls a radio-communication device provided in the laundry apparatus to communicate with an outside.

The radio-communication processing unit 122 processes the information received from the radio-communication device 130 of the laundry apparatus to store the processed information in the radio-communication memory part 124 or to transmit the processed information to the operation control part 110.

The laundry apparatus having the radio-communication device 130 is wirelessly in communication with a mobile phone 200 having an identical radio-communication device to the radio-communication device 130.

The radio-communication device 130 of the laundry device may be a Bluetooth communication module.

Bluetooth is a kind of communication technology system to connect portable devices such as mobile phones, portable PC with network access points and other peripheral devices wirelessly, with a small size, low cost and less electricity consumption, and it has been popular recently.

The Bluetooth communication module is a series of chips enabling Bluetooth communication, a bonding of circuits such as memories and antennas having radio-communication programs. That is, Bluetooth communication module means that a set of chips and a set of antennas are modulated into a single chip to enable Bluetooth communication.

If the radio-communication device installed in the mobile phone and the laundry apparatus is a Bluetooth module, the radio-communication control program is referenced to as a Bluetooth module control program. As a result, if the Bluetooth function of the mobile phone is active, the radio-communication control program controlling Bluetooth module is pairing with the laundry apparatus. If the mobile phone and the laundry apparatus are pairing, binary information exchange is possible.

The mobile phone is a portable device and it can selectively activate Bluetooth communication function to save electricity. However, Bluetooth module installed in the laundry apparatus consumes substantially little amount of electricity and thus it may be preset to inspect the communicable mobile phone continuously. Also, it is selective in the laundry apparatus to activate the Bluetooth mode.

If the radio-communication control program installed in the mobile phone is run, the laundry apparatus and the mobile phone are pairing, prior to the exchange of the information.

In electric appliances having Bluetooth communication module, binary data transmission is possible and thus, wireless communication is possible without an auxiliary program.

The mobile phone 200 having the radio-communication device 230 with Bluetooth communication module may send and receive data to and from the laundry apparatus via the radio-communication.

The reason why the mobile phone 200 is in radio-communication with the laundry apparatus according to the exemplary embodiment is that the laundry apparatus is controlled by the mobile phone 200 and that the information received from the outside is transmitted to the laundry apparatus.

Commonly, at least one of the infrared communication module and Bluetooth communication module is provided in a recently released mobile phone 200.

If such the mobile phone 200 having the radio-communication device 230 controls the laundry apparatus and the information on the operational state of the laundry apparatus is identified via the mobile phone 200, this may replace the remote control and the production cost may be reduced and functions which the conventional remote control cannot provide may be embodied.

To control the laundry apparatus according to the exemplary embodiment by using the mobile phone 200, a program to control the laundry apparatus should be mounted in the mobile phone 200.

That is, a radio control program is stored in the auxiliary storage space of the radio-communication memory part 124 and the radio control program is transmitted and installed to control the laundry apparatus.

The radio control program installed in the mobile phone 200 to control the laundry apparatus may be downloaded from a computer via the internet or a mobile web of the mobile phone itself.

Here, it is premised that such the radio control program is downloaded via a web page provided by the manufacturer of the laundry apparatus.

At this time, there is limit of a place where the internet service should be provided or of a mobile phone which should be highly efficient one.

If the internet service is not available in the residence area of the user or the user's mobile phone cannot be connected with the mobile web, a method of transmitting and installing the radio control program to and in the mobile phone 200 is necessary.

According to the laundry apparatus according to the embodiment, the radio control program transmitted and installed in the mobile phone 200 to control the laundry apparatus may be stored in the radio-communication memory part 124.

The radio-communication control program run in the radio-communication processing unit 122 to control the radio-communication device 130 is stored in the radio-communication memory part 124 and the auxiliary storage space is provided in the radio-communication memory part 124 as mentioned above. Thus, the radio control program which will be transmitted to the mobile phone may be stored in the auxiliary storage space.

The radio control program which will be installed in the mobile phone 200 having the radio-communication device may be stored in the auxiliary storage space in a production line of the laundry apparatus.

If then, the radio-communication device 130 may transmit the radio control program to the mobile phone. The radio-communication control part 120 packetizes the radio control program which will be transmitted via the radio-communication device of the laundry apparatus and the radio-communication device 130 transmits the packetized radio control program to the mobile phone.

The radio control program may be wirelessly transmittable to the mobile phone via the radio-communication device 130 of the laundry apparatus.

The radio control program is transmitted to the mobile phone 200 and it is installed in the mobile phone 200 to run.

If a control signal of the laundry apparatus is inputted by a user, the radio control program installed in the mobile phone transmits a control signal controlling the laundry apparatus to the laundry apparatus via the radio-communication device of the mobile phone.

The control signal may be a control signal to perform specific works, for example, start drying or add rinsing. The control signal of the laundry apparatus is transmitted to the operation control part of the laundry apparatus via the radio-communication device 130 and the radio-communication control part 120, so as to control the various components of the laundry apparatus.

The radio control program has a function of inspecting the information on the operation state of the laundry apparatus which is transmitted from the operation control part 110 of the laundry apparatus, rather than transmitting the control signal to control the laundry apparatus.

The information on the operation state of the laundry apparatus which is transmitted to the mobile phone may be displayed via the mobile phone, with the radio control program running on the mobile phone. It is premised that such the radio control program supports a function of displaying the information on the operation state of the laundry apparatus on a display device of the mobile phone.

Specifically, the information the user has selected, for example, an operation state of the laundry apparatus and a remaining time of washing and the information, for example, operation completion of the laundry apparatus may be informed of the user. As a result, the user may start to dry or wash another laundry without waste of time.

Such the information of the operation sate and the information of the operation completion may be collected to the radio-communication processing unit 122 from the operation control part 110, or such the information may be information of an operation state which is stored in each of the storage spaces.

A selection mode may be provided such that the user may select the information on the operation state which will be transmitted by the control part of the laundry apparatus wirelessly

That is, the radio-communication control part collects the information on the operation state of the laundry apparatus from the operation control part and it transmits the collected information to the mobile phone via the radio-communication device of the laundry apparatus.

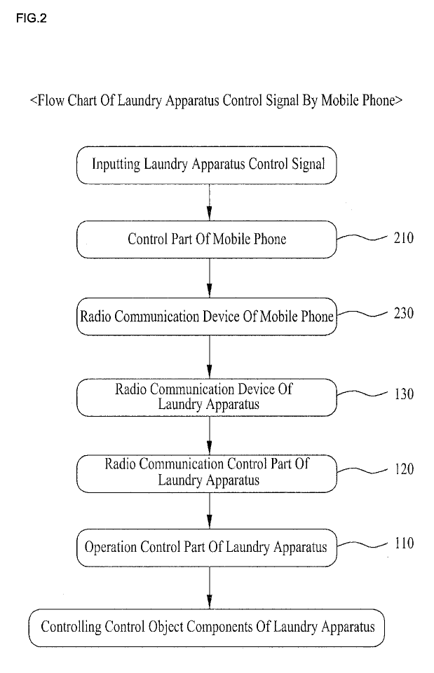

FIG. 2 is a flow chart of a control signal if the laundry apparatus according to the embodiment is controlled by the mobile phone 200.

The user uses a keypad of the mobile phone 200 having the radio control program and the user selects a control signal of the laundry apparatus. For example, the control signal may include “start washing mode” and “start drying mode”

Such the control signal is transmitted to the radio-communication device 230 of the mobile phone from a control part 210 of the mobile phone 200 and it is packetized to enable the radio-communication. Hence, the packetized signal is transmitted to the radio-communication device 130 of the laundry apparatus wirelessly.

The control signal transmitted to the radio-communication device 130 of the laundry apparatus may be transmitted to the operation control part 110 of the laundry apparatus via the radio-communication control part 120.

The operation control part 110 controls each of the components based on the control signal.

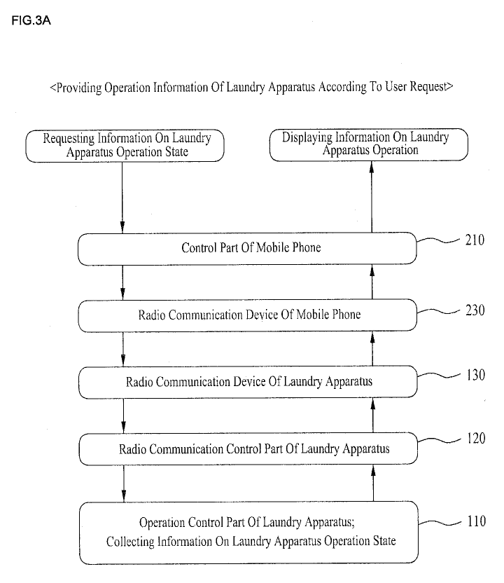

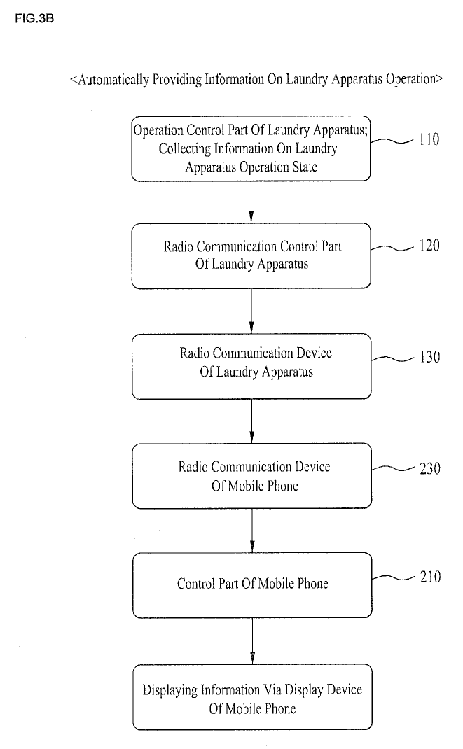

FIG. 3 is a diagram illustrating a method of providing information with the mobile phone 200 from the laundry apparatus.

FIG. 3A shows that the information on the operation state of the laundry apparatus is supplied to the mobile phone 200 by the user's demand and FIG. 3B shows that the laundry apparatus according to the exemplary embodiment automatically supplies information to the mobile phone 200.

First of all, in reference to FIG. 3A, it will be described that the information on the operation state of the laundry apparatus is transmitted to the mobile phone 200.

The radio-communication control part 120 may collect or transmit the information on the operation state of the laundry apparatus if a request signal of the information on the operation state of the laundry apparatus is received.

That is, if the request signal of the information on the operation state of the laundry apparatus is inputted by the user, the request signal is transmitted to the control part 210 of the mobile phone 200, the radio-communication device 230 of the mobile phone 200, the radio-communication device 130 of the laundry apparatus, the radio-communication control part 120 of the laundry apparatus and the operation control part 110 of the laundry apparatus.

The operation control part 110 collects the information on the operation state of the laundry apparatus according to the request signal of the information on the operation state which is transmitted to the operation control part 110.

During the collecting of the information, the operation processing unit 112 of the operation control part 110 may temporarily store the information, which will be transmitted to the mobile phone, in the operation memory part 114.

Once the collection of the information on the operation state of the laundry apparatus is complete, the completion of the collecting is transmitted in the opposite direction of the passage of the request signal of the information on the operation state. It is transmitted to the operation control part 110, the radio-communication control part 120, the radio-communication device 130 of the laundry apparatus, the radio-communication device 230 of the mobile phone 200 and the control part of the mobile phone, and then it is displayed via a LCD device of the mobile phone 200.

If the information on the operation state of the laundry apparatus is requested by the user as mentioned above, the operation control part 110 of the laundry apparatus may collect the information. Here, it is preferable that the information on the operation state of each component of the laundry apparatus is collected at predetermined intervals in advance during the operation of the laundry apparatus. Hence, if the user inputs the request signal of the information on the operation state, the information corresponding to the request signal is transmitted to the mobile phone 200.

The pre-collected information on the operation state may be stored in the operation memory part 114 composing the operation control part 110. The operation control part 110 may be programmed to collect the information on the operation state at predetermined intervals during the operation of the laundry apparatus.

FIG. 3B shows that the laundry apparatus according to the embodiment provides the user with the information on the operation state automatically, unless the request signal of the operation state is inputted by the user.

The information on the operation state of the laundry apparatus may include information on operation completion of the laundry apparatus, for example, “washing is complete” and “drying is complete”, which requires the user's action.

The information which is the automatic transmission object is stored in the operation control program run in the operation control part 110. At this time, it is preferable that the information automatically transmitted is selected or added by the user.

For example, if the user wishes to identify the time of the last rinsing cycle during the washing course, the user may preset the time of the last rinsing to be transmitted to the mobile phone via the control part wirelessly. As a result, the information on the completion of the washing or drying is preset to be transmitted to the user even without a separate setting and the other auxiliary information may be preset to be transmitted to the user according to the user's selection.

On the laundry apparatus directly may the user select the information which will be automatically transmitted or a system may be built for the user to select the information via the mobile phone 200.

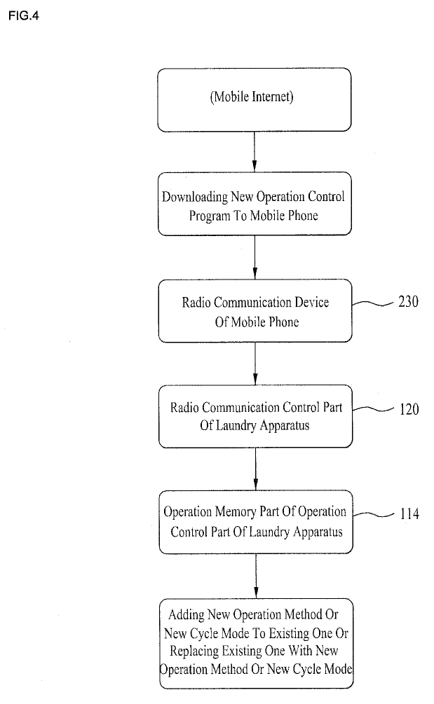

FIG. 4 shows a transmission passage of the operation control program if the operation control program of the laundry apparatus is added or changed.

The conventional laundry apparatus is controlled by the operation control program which is stored in the operation memory part 114 of the operation control part 110. At this time, the washing efficiency of the same laundry apparatus can be changed by a new operation control program.

However, according to the conventional laundry apparatus, it is impossible to add or change a new operation program.

In contrast, it is possible in the laundry apparatus according to the present invention to add a new operation control program or replace the existing operation control program with a new operation control program, if a new operation control program of the laundry apparatus is transmitted to the laundry apparatus via the mobile phone.

That is, since the laundry apparatus according to the exemplary embodiment includes the radio-communication device 130, a new operation control program is downloaded to the mobile phone 200 and the downloaded operation control program is transmitted to the operation control part 110 of the laundry apparatus by using the radio-communication devices 130 and 230 provided in the mobile phone 200 and the laundry apparatus, respectively.

A new operation control program may be downloaded to the mobile phone 200 via the internet or mobile internet. The mobile phone 200 generally includes an extra storage space and information as well as files may be stored in the extra storage space temporarily.

Accordingly, the operation control program of the laundry apparatus is downloaded to the mobile phone 200 and the downloaded program is transmitted to the operation control part 110 by using the radio-communication devices 130 and 230. Hence, if the operation control program is installed or stored, the laundry apparatus may be operable according to the new operation control program.

That is, the operation control program may include a new operation mode of the laundry apparatus. As a result, if a new efficient washing course is developed, the user may download the newly developed course to the mobile phone via a wire or wirelessly from the manufacturer of the laundry apparatus, such that the user may transmit the newly developed course to the laundry apparatus.

Therefore, according to the embodiment of the present invention, without an auxiliary remote control, the user may identify the information of the laundry apparatus remote or may control the laundry apparatus.

Furthermore, the laundry apparatus according to the embodiment may receive a new operation control program from the mobile phone having the radio-communication device and the new operation control program may be installed in the laundry apparatus. As a result, changing demands of consumers may be satisfied.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A laundry apparatus comprising:
a laundry device washing or drying laundry;
an operation control part controlling components of the laundry device;
a radio-communication device able to radio-communicate with a mobile phone, the mobile phone having a radio-communication device which communicates to the radio-communication device; and
a radio-communication control part exchanging data with the operation control part, the radio-communication control part controlling the radio-communication device.

2. The laundry apparatus of claim 1, wherein the radio-communication control part comprises,
a radio-communication processing unit processing data generated during the radio-communication; and
a radio-communication memory part in which a radio-communication control program is stored, with an auxiliary storage space, the radio control program run in the radio-communication processing unit to control the radio-communication device.

3. The laundry apparatus of claim 2, wherein a radio control program is stored in the auxiliary storage space of the radio-communication memory part, the radio control program which is transmittable to and installable in the mobile phone to control the laundry apparatus.

4. The laundry apparatus of claim 3, wherein the radio control program is wirelessly transmitted to the mobile phone via the radio-communication device of the laundry apparatus.

5. The laundry apparatus of claim 1, wherein the radio-communication control part collects information on an operation state of the laundry apparatus from the operation control part to transmit the collected information to the mobile phone via the radio-communication device of the laundry apparatus.

6. The laundry apparatus of claim 5, wherein the information on the operation state which is transmitted to the mobile phone is selected information by a user.

7. The laundry apparatus of claim 5,
wherein the information on the operation state transmitted to the mobile phone being displayed via the mobile phone, with the radio control program being run.

8. The laundry apparatus of claim 5, wherein the radio-communication control part collects or transmits the information on the operation state of the laundry apparatus, if a request signal of the information on the operation state is received.

9. The laundry apparatus of claim 8, wherein the information on the operation state of the laundry apparatus comprises information on operation completion of the laundry apparatus.

10. The laundry apparatus of claim 3, wherein the radio control program transmits a control signal of the laundry apparatus to the laundry apparatus via the radio-communication device of the mobile phone, if a control signal of the laundry apparatus is inputted by a user.

11. The laundry apparatus of claim 10, wherein the control signal is transmitted to the operation control part, after passing the radio-communication device and the radio-communication device of the laundry apparatus, to control the components of the laundry device.

12. The laundry apparatus of claim 1, wherein a new operation control program of the laundry apparatus stored in the mobile phone is added or an existing operation control program stored in the operation control part is replaced with the new operation control program, if a new operation control program of the laundry apparatus stored in the mobile phone is transmitted.

13. The laundry apparatus of claim 12, wherein the operation control program comprises a new operation mode of the laundry apparatus.

14. The laundry apparatus of claim 1, wherein the radio-communication device of the mobile phone and the radio-communication device of the laundry apparatus are Bluetooth modules.
